(19) United States
(12) Patent Application Publication
(10) Pub. No.: US 2006/0118984 A1
(43) Pub. Date: Jun. 8, 2006

(54) Method for producing porous sintered bodies

(75) Inventors: Jorg Farber, Breitenwang (AT); Manfred Jaeckel, Loxstedt (DE)

Correspondence Address: LERNER GREENBERG STEMER LLP, P O BOX 2480, HOLLYWOOD, FL, 33022-2480, US

(73) Assignee: Plansee Aktiengesel

(21) Appl. No.: 10/543,933

(22) PCT Filed: Jan. 26, 2004
(86) PCT No.: PCT/AT04/00025

§ 371 Date: Aug. 28, 2005

(30) Foreign Application Priority Data
Jan. 30, 2003 (AT) GM 42/2003

(51) Int. Cl. B29C 65/00

(52) U.S. Cl. 264/44

(57) ABSTRACT

The process of the invention for producing highly porous shaped sintered parts comprises the foaming of thermoplastically flowable molding compositions in the temperature range 80-130° C. An important feature of the process is the use of expandable polystyrene as blowing agent, and also of binder components matched thereto. During foaming, intrinsically closed, cell-like polystyrene foam particles are formed, which allows the manufacture of mechanically strong shaped sintered bodies having a proportion of pores of up to 85% by volume combined with high homogeneity of the pore diameter. The process is employed for the manufacture of open- or closed-porosity shaped sintered ceramic and/or metallic bodies.

The invention relates to a process for producing a shaped cellularly porous sintered body which comprises the manufacturing steps of preparation of a thermoplastically flowable molding composition by mixing ceramic and/or metal powder with binder components and incorporation of organic and/or inorganic blowing agents, conversion of the molding composition into a molten state and introduction into a shaping device, foaming of the molding composition by means of the blowing agent, solidification of the foam molding composition, removal of blowing agents and organic components and sintering of the shaped body which has been treated in this way.

It is known that metallic and/or ceramic shaped bodies can be manufactured by pressing and sintering suitable starting powders.

It may be appropriate to add a ductile binder, for example a ductile metal powder in the production of cemented carbide, to the matrix powder in order to obtain pressable and sinterable products.

A comparatively recent technology for producing shaped ceramic and/or metallic sintered bodies is the MIM (metal injection molding) process in which the ceramic and/or metallic matrix powder particles are mixed with organic binding components, the mixture is usually brought to the desired shape in the thermoplastic state, the molding is solidified and then freed of its organic and/or inorganic binder components by means of pyrolysis and/or by dissolution and extraction and is finally sintered to produce the approximately pore-free dense shaped body. As an alternative to injection molding, shaping is effected, for example, by extrusion.

While the objective is usually to bring the shaped sintered bodies to a very pore-free final state, there are also applications of sintered bodies in which a particular pore structure is required. Targeted pore structures in sintered bodies can be produced, for example, by mixing the starting matrix powder with a pulverulent space occupier, with the space occupier particles usually being chemically leached and/or removed by means of thermal decomposition from the shaped composite material before or during the sintering process so that voids or pores take their place.

It is also known that pore structures in shaped bodies can be produced by blowing gases, e.g. argon or nitrogen gas, into a metal melt. As an alternative, sintered bodies having a pore structure are produced by introducing blowing agents as additives as homogeneously as possible into a matrix material admixed with thermoplastic binder and heating this composite or this molding composition to the vaporization or foaming temperature of the blowing agent. Here, bubble-like gas spaces are formed in the thermoplastic or molten molding composition, or foamed structures are formed from the thermoplastic or molten molding composition, and these stabilize on cooling and transformation of the molding composition into a solid state and then allow extraction of the gas inclusions or the residue blowing agent to leave pores. In parallel, the binders added are extracted. The ready-to-use mechanical stabilization of the shaped body is effected by means of an additional sintering step. The achievable quality of such finished, shaped, porous sintered bodies, especially their mechanical stability, mechanical machinability, homogeneity of the pore structure, percentage pore volume which can be achieved, depends greatly on the process conditions employed, on the auxiliaries, blowing agents and binders and also on the preparation of all materials introduced into a molding composition.

The large range of organic and inorganic binders available for these purposes to date is largely the result of progress in MIM technology.

Similarly, a large number of different, expandable materials have been described as blowing agents for producing pore structures in shaped bodies manufactured from powders.

However, some specific combinations of matrix powder, binder and blowing agent in combination with the respective process conditions have a frequently unforeseeable, variable influence on the result or on the quality of such shaped porous bodies.

Thus, the patent U.S. Pat. No. 5,213,612 describes a process for producing a porous metal body, according to whose examples an aqueous suspension of metal powder and a foamable blowing agent are mixed in a prescribed volume ratio, foamed and converted into the solid shaped body by drying. On subsequent heating of the shaped body (foaming agent with metal powder dispersed therein) to a first temperature stage of 600-1200° C. in a reducing atmosphere, foaming agent decomposition with simultaneous interparticle diffusion and metallic bonding of the powder particles occurs. The temperature is subsequently raised to a sintering temperature matched to the respective metal and the metal powder is sintered to form a porous body. As a foaming agent which can be used, mention is made of an isocyanate-coated polyoxyethylene polyol which makes the use of an additional binder superfluous. According to one example, a 50% expansion in volume occurs on foaming. A disadvantage of this process is the use of water in combination with polyurethane or polyethylene binders, which allows the composition formed in this way only a low level of thermoplastic properties and thus allows it to foam to a very limited extent (in terms of volume). Shrinkage occurs after foaming. The proportion of pores which can be coped with in the sintered body under practical conditions is 10-20% by volume, which generally rules out the formation of cellular pore structures.

DE 177 15 20 A1 describes a process for producing ceramic compositions having a honeycomb structure in the interior and thus a smooth surface by casting, in which polymers having a bead structure are stirred into the heated ceramic slip and the cast shaped body solidifies on cooling. The preferred polymer is polystyrene containing blowing agent, which has, depending on the desired bead size, been prefoamed.

A disadvantage of this process is an unsatisfactory controllability of the bead distribution and arrangement in the ceramic slip, which, even in the case of only moderate requirements in terms of the minimal mechanical strength of the cooled ceramic mass, restricts the use of the process to the manufacture of shaped bodies having only a low pore volume. The process does not provide for removal of the polystyrene beads from the composition.

Another process of the type mentioned at the outset is described in EP 0 765 704. The important features of the process are the separate preparation of two different components for a molding composition, firstly an aqueous solution comprising the foaming or blowing agent in a resin-like binder and secondly a solution comprising metal powder and a water-soluble, resin-like binder, the two of which are combined immediately before the planned foaming process. The foaming step is carried out in an atmosphere having a humidity of at least 65%. The water-soluble resin binder stabilizes the pores formed in the composition on foaming during foaming and subsequent drying. The water-soluble resin binder having a temperature-dependent viscosity allows targeted setting of the viscosity of the molding composition as required in the individual manufacturing steps. Examples of such a water-soluble resin binder which are explicitly mentioned are methylcellulose, hydroxypropylmethylcellulose, hydroxyethylcellulose, carboxymethylcellulose, ammonium, ethylcellulose and polyvinyl alcohol. Mention is also made of volatile hydrocarbons having from 5 to 8 carbon atoms in the hydrocarbon radical as agents for forming gas bubbles or pores in the molding composition, with explicit mention being made of pentanes, hexanes, octanes, benzenes and toluenes. The foamable suspension can further comprise organic plasticizers. Many oils, esters, glycerols and other organic substances are explicitly mentioned. The possible addition of specific agents for stabilizing the foam state and the microcells formed is envisioned. Unlike the case of the previous use of commercial polyurethane as foaming or blowing agent, this process is said to make it possible to produce a crack-free and thus mechanically stable, porous sintered body. The process steps described in more detail in the examples allow the sensitivity of the process to be seen. In actual fact, this process does not allow porous sintered bodies which have a high proportion by volume of pores and are sufficiently mechanically stable for the majority of applications to be obtained. Moreover, the term “sintered bodies having a honeycomb structure” used there does constitute a restriction of this background.

EP 0 460 392 A1 describes a process for producing foamable metal bodies, which comprises the manufacturing steps of mixing of metal powder and gas-releasing blowing agent powder to form a molding composition, hot compacting of the molding composition under conditions which make bonding and mechanical consolidation of the metal powders by means of diffusion possible and at the same time enclose the blowing agent in a gastight manner and prevent decomposition of the blowing agent. Furthermore, the compacted molding composition is brought, in an open vessel or in a mold, to a temperature which is sufficiently high for the matrix metal to melt and the blowing agent to decompose so as to foam the melt.

Depending on the heating and cooling rate and the foaming time at maximum temperature, foam bodies having a different pore size and structure are obtained. Blowing agents mentioned are titanium hydride, aluminum hydroxide and sodium bicarbonate.

This process allows metal foams having a high and homogenous pore volume to be produced only in an unsatisfactory manner. The low molding composition viscosity necessary for foaming requires heating to the usually high metal melting point, which has many disadvantages. During the foaming process, undesirable combination of individual gas bubbles accompanied by the risk of collapse of the foaming molding composition and formation of pores which are insufficiently controllable in terms of their size distribution occurs.

It is thus an object of the present invention to provide an improved process for producing a highly porous metallic and/or ceramic shaped sintered body by means of foaming of a molding composition with the aid of a blowing agent. The disadvantages of known processes, for example time-consuming and costly process steps, high foaming temperatures, shrinkage of the shaped body after foaming and insufficient ability to influence the desired pore structure, even in the case of only moderately high total pore volumes, should be avoided or brought to a significantly lower level.

This object is achieved in an inventive manner for the process described at the outset by the process features specified in the claims.

The process can thus be employed for producing highly porous shaped sintered bodies having a cellular pore structure, i.e. the shaped body has comparatively thin cell walls relative to the volume of the pores formed by them. The finished shaped sintered bodies have a load-bearing sintered framework composed of the matrix materials metal and/or ceramic, free of additives, or only with insignificantly small residue amounts of additives originally added to the molding composition. They have a high mechanical strength. The sintered cell walls are largely free of microporosity, but can be made microporous if desired.

The cell-liked pores preferably have, depending on requirements, a largely homogeneously uniform mean pore diameter in the range from 0.1 to 10 mm in the finished sintered body, in contrast to a microporosity as is known from sintering technology which is normally smaller by at least a power of ten. The pore volume in the sintered body is preferably 60-85% by volume. Such high proportions by volume of pores are achievable only in the case of a strictly geometrically uniform, for example honeycomb-like, arrangement of the pores in the shaped sintered body.

To form large-pored cellular structures, the polystyrene blowing agent used is preferably commercial EPS (expandable polystyrene), i.e. unfoamed polystyrene beads having particle diameters of preferably from 0.1 to 5 mm and containing the volatile hydrocarbons pentane or hexane in a proportion of from 1 to 8% by weight as expanding agent.

To exert a specific influence on the foaming characteristics, it is also possible to use copolymers of monomeric styrene with proportions of acrylic esters or acrylonitrile in place of the pure EPS beads.

A large number of thermoplastic binder materials and combinations of individual binder components are known, predominantly from MIM technology. A wide range of binders which can be matched to the respective requirement can be achieved by means of a component selection with which those skilled in the art are familiar. However, to perform the present invention correctly, ensuring a suitably low melt viscosity of the total molding composition at the foaming temperature of from 80 to 130° C. which is necessary to achieve liberation of gas from the blowing agent is of great importance.

In line with the terminology used in MIM technology, a molding composition comprising a mixture of preferably organic binder components and matrix powder is referred to as molten when it has a low-viscosity, slurry-like consistency.

The appropriate combination of blowing agent according to the invention and thermoplastic binder components matched thereto allows foaming of the molding composition to comparatively very high pore volumes, measured relative to the known prior art. In preferred embodiments of the process, shaped sintered bodies having cell-forming pores in a proportion of from >30 to >85% by volume in the shaped sintered body are produced.

A plasticity of the molding composition which is sufficient for foaming is still present at a proportion by volume of metallic and/or ceramic matrix powder of significantly above 50% and a correspondingly lower proportion of binder in the prepared, unfoamed molding composition. High proportions of matrix powder significantly aid the subsequent sintering to form the mechanically strong shaped sintered body or make this possible in the first place. Known processes directed at achieving high pore volumes did not allow comparably favorable proportions by volume in practice. Rather, known processes demand big compromises between sintering stability and high pore volume in the shaped sintered body.

Mechanically strong shaped sintered bodies having a stable sintered framework and a high proportion by volume of pores can be obtained according to the invention by the use of EPS as blowing agent, because this leads, in contrast to blowing agents corresponding to the known prior art, not only to liberation of gases for the purpose of gas bubble formation and pore formation in the molding composition but especially to the formation of foamed, mechanically load-bearing, intrinsically closed polystyrene foam spheres. Only in this way can the collapse of foamed melts which is a risk in processes known hitherto be avoided above a particular, comparatively small pore size. In the present process, neither combination of individual small gas bubbles to form a large gas bubble, or pore, nor collapse of foamed molding compositions because of insufficient thermoplasticity on exceeding the surface tension between gas bubble and molding composition occur.

As a further advantage of the process of the invention, a mechanical stabilization of the pores in the foamed molding composition which has not been achieved hitherto can be achieved by means of matching in a manner with which those skilled in the art will be familiar of the chemical/physical properties of the binder components to the blowing agent used according to the invention. It is usual to remove the major part of both the binder components and the expanded polystyrene spheres from the molding composition by means of a leaching process in organic solvents such as acetone or ethyl acetate in a step following foaming. The mechanical stability of the molding is lost in this step. The process of the invention uses high polymers such as polyamides which are insoluble in the abovementioned solvents customary for extraction as predominant binder component.

Further binder components used are plasticizers, surfactants and mold release agents which are as readily soluble as polystyrene in acetone and ethyl acetate at temperatures above 30° C. These additional components which are soluble in the solvent can lead to microporosity of the (still unsintered) cell walls and aid the removal of solvents and substances dissolved therein. It is now the high polymer which cannot be leached from the foamed molding composition in the extraction process which, even at a proportion of macropores of 85% by volume in the molding composition, gives the metallic and/or ceramic powder particles sufficient mechanical strength for, firstly, the extraction step occurring without volume shrinkage and also for manipulation of the extracted, unsintered shaped body and finally for the initial phase, which is critical in terms of maintenance of the shape, of the sintering process of the metallic and/or ceramic powder particles up to the time that the binder has been pyrolyzed without leaving a residue at 500° C.

The proportion of binder in the molding composition has to be matched to the materials used in the molding composition and to the process parameters for processing. If this proportion is too high, it impairs sintering of the matrix powders during the subsequent sintering process. If the proportion is too small, the foamed molding composition has a mechanical strength which is below the minimum value required for manipulation and further processing.

For the foaming process, the prepared molding composition is brought in a suitable shaping device to a temperature suitable for volatilization of the expanding materials in the blowing agent and at the same time the melting point of the molding composition. Foaming is more controlled and uniform, the more uniformly the polystyrene particles or EPS beads are distributed in the molding composition and the more homogeneous the temperature distribution in the molding composition.

Particularly good results in respect of cell homogeneity, cell structure and proportion by volume of pores in the molding composition can be achieved when a mold provided with fine slits is used as shaping device in a pressure-controlled autoclave.

The process steps of shaping of the molding composition and foaming can be carried out according to a number of different methods which have already been practiced hitherto.

Shaping and foaming of the molding composition by means of known injection-molding processes has been found to be particularly useful for the manufacture of geometrically complex shaped parts.

Simply dimensioned shaped bodies such as plates, disks or spheres can be produced economically by pressing of a pulverulent EPS-containing molding composition to form compacts and subsequent foaming by means of steam in a mold perforated by slits. In one process variant, the compacts may, if desired, be provided with a nonfoamable surface layer in a subsequent powder pressing procedure. This makes it possible to obtain plates or disks having a pore-free outer layer.

In another economical sequence of steps according to the invention, the EPS is incorporated homogeneously into the molding composition melt at temperatures below 80° C. in a palletizing extruder and the strands of composition exiting at the perforated plate of the extruder are chopped by means of underwater pelletization. In order to avoid premature gas losses from the EPS beads, it is advantageous to carry out the underwater pelletization under an elevated medium pressure. Such EPS-containing pelletized molding compositions can be processed further without problems using the equipment customary in plastics processing to produce foamed molding composition bodies.

In a similar process variant, EPS-containing pellets are introduced directly into a vapor-permeable mold and at the same time foamed, as is carried out widely using prefoamed EPS spheres in the packaging industry. The manufacture of large-area and large-volume shaped parts can also be carried out by means of this preferred process.

When extrusion is incorporated into the process of the invention, the molding composition is brought to the melting point and at the same time the foaming temperature in a screw extruder or ram extruder and is pushed through a shaping die under a high pressure of, for example, from 10⁶ to 10⁸ pascal. The melt exiting from the die foams and increases its volume and is solidified in its enlarged state with simultaneous cooling in a calibration unit and taken off continually in this form.

In one variant of the extrusion sequence, the molding composition is cooled under high pressure after exiting from the extrusion die to prevent foaming. In a subsequent sequence of steps, the shaped composition is heated again, foamed in a mold matched to its volume expansion, cooled and treated further in accordance with the features of the invention. This process variant is employed, in particular, for the manufacture of highly porous, large-area shaped sintered parts having either an open or closed cell structure.

In contrast to the preferred production of shaped sintered bodies having closed pores or cells, the process of the invention gives open cell structures whenever either the expandability of the molding composition melt is too small for the speed and extent of foaming, and this can be controlled in a targeted way, or whenever the foaming process is influenced, for example by an increase in the proportion of EPS in the molding composition, so that the amount of molding composition to be made available locally for formation and retention of closed cells is not sufficient, so that the EPS spheres which are expanded further come into direct area contact with their adjoining neighbors.

With regard to the choice of metallic and ceramic matrix materials as suitable for the process of the invention, there is only the restriction that they have to be in the form of sinterable powders, a requirement which is common knowledge to powder metallurgists. Preferred ceramic matrix materials are the oxides of aluminum, silicon and zirconium, and also silicon nitride and mixtures thereof. Metallic matrix materials which are being found to be particularly useful are metals and alloys from the group consisting of Fe, Co, Ni, Cu, Ti, Ta, Mo, W and the noble metals, and also metallic oxides, hydrides and cemented carbides.

Shaped sintered bodies produced by the process of the invention have a wide range of applications. They are employed predominantly in the field of lightweight components and for parts having a comparatively low thermal conductivity, and also in the case of open-pored shaped sintered parts in the field of mechanical filters and catalysts.

The invention is illustrated by the following examples.

### EXAMPLE 1

describes the production of a porous shaped sintered chromium-nickel steel body. Water-atomized chromium-nickel powder of the grade 316 L (from Pamco, Japan, particle size: 90% less than 15 μm) is intensively mixed and kneaded with binder components composed of polyamide, plasticizer, wetting agent and molar release agent (the binder) in a weight ratio of 93.5% by weight of 316 L powder, 6.5% by weight of binder at about 100° C. in a kneader until a low-viscosity melt has been obtained.

This composition is discharged from the kneader, solidified by cooling and milled to produce powder having a particle size of less than 0.3 mm. 140 g of this powder are mixed with 13 g of EPS beads (Styropor P 656 from BASF, particle size: 0.3-0.4 mm) in a laboratory mixer and pressed at room temperature and a pressing pressure of 200 bar to form a powder compact having dimensions of 60×90×7.2 mm³.

This compact is introduced into a 20 mm high Al frame having dimensions of 70×100 mm², and its upper and lower surfaces are covered with filter paper and a fine woven mesh and subsequently on each side with 6 mm thick Al plates so that a closed, pressure-resistant and nevertheless vapor-permeable mold is produced. The vapor permeability is ensured by holes in the plates which have a diameter of 4 mm and are located 3 mm apart.

The mold filled with the compact is exposed for 4 minutes to steam which has a temperature of 120° C. and is under a gauge pressure of 0.7 bar in a steam autoclave. After the autoclave has been cooled to below 100° C., the mold is taken out and cooled to about 30° C. under cold water. The compact which has expanded to form a shaped body having the dimensions 70×100×20 mm³ is removed from the mold, freed of the filter paper and dried at 60° C. for 2 hours. It loses 2.5% by weight of moisture during drying. The shaped body is then treated in ethyl acetate at a temperature of 50° C. as solvent for 24 hours while resting on a perforated support plate. The already porous shaped body soaked with solvent and substances dissolved therein is subsequently taken from the bath and freed of the solution by means of vacuum distillation. The remaining, still unsintered shaped body has a weight of 137 g and external dimensions which are unchanged from those of the foamed shaped body. Comparison with the weighed-out weight of the molding composition (140 g+13 g=153 g) indicates a weight loss of 16 g, which corresponds, based on 17.2 g of theoretically extractable material, to a proportion of 93.0%. In the first stage of the concluding sintering of the shaped body, the still not extracted proportion of polystyrene and binder components, in particular polyamide, is removed in volatile form from the shaped body by means of pyrolysis at 500° C. In the further sintering process over a period of 60 minutes at 1032° C., a shaped sintered body having dimensions of 61.5×88×17.3 mm³ and a weight of 130 g is produced. This corresponds to a density of about 1.4 g/cm³ or a pore volume of 82%.

The mean diameter of the largely uniformly sized pores or cells in the shaped sintered body is about 0.60 mm.

### EXAMPLE 2

describes the production of a porous shaped sintered Al₂O₃ body.

For this purpose, a sinterable Al₂O₃ powder having a mean particle size of 3 μm and a purity of 99.80% (grade CT 3000 SG, ALCOA) is intensively mixed and kneaded with binder components (polyamide, plasticizer, wetting agent and mold release agent) at 100° C. in a kneader until a low-viscosity melt has been obtained. The proportions by weight are 86.0% by weight of CT 3000 SG and 14.0% by weight of binder components.

In a manner analogous to example 1, the kneaded composition is discharged from the kneader, cooled and milled to give powder having a particle size of less than 0.3 mm.

65 g of this powder composition are subsequently mixed with 25 g of EPS beads (Styropor P 656, BASF, particle size: 0.3-0.4 mm) in a laboratory mixer and pressed at room temperature under a pressing pressure of 200 bar to give a compact having the dimensions 60×90×12 mm³.

Using a procedure analogous to example 1, the compact is processed to produce a foamed compact having dimensions of 70×100×20 mm³ and subsequently stored in ethyl acetate as solvent to extract soluble substances.

The shaped body obtained after the vacuum distillation is 62 g heavier and has the unchanged dimensions of 70×100×20 mm³.

The weight loss compared to the weighed-out components is 28 g at this point in time, which corresponds to a value of 89% of the theoretically extractable amount of material of 31.5 g.

After pyrolysis of the remaining polystyrene and binder components at 500° C. in air and sintering for 60 minutes at 1550° C., the shaped sintered body has the dimensions 60×86×17 mm³ and a weight of 56 g.

This corresponds to a density of about 0.64 g/cm³, or a pore volume of 84%.

The mean diameter of the macropores is 0.60 mm.

The sintered body is so mechanically stable or fracture-insensitive that it can be manipulated and utilized without restrictive precautions with only a small risk of damage.

1-15. (canceled)

16. A method of producing a cellular shaped sintered body, which comprises the following manufacturing steps:
preparing a thermoplastically flowable molding composition by mixing ceramic and/or metal powder with binder components and incorporating expandable polystyrene particles forming blowing agents;
converting the molding composition into a molten state and introducing the molding composition into a mold leaving room for expansion of the molding composition;
foaming the molding composition by way of the blowing agent at temperatures between substantially 80° and substantially 130° C. in a mold to form a foamed molding composition, and to form individual polystyrene foam particles each taking up a closed space in the molding composition and having a narrow diameter distribution; and
solidifying the foamed molding composition, removing the blowing agents and organic components, and sintering the thus-treated shaped body.

17. The method according to claim 16, which comprises using bead-shaped polystyrene particles having a mean diameter of from 0.1 to 5 mm and a small scatter of the diameter.

18. The method according to claim 16, wherein the blowing agent is a copolymer of monomeric styrene and acrylic esters or acrylonitrile.

19. The method according to claim 16, wherein the expandable agent is polystyrene comprising pentane or hexane.

20. The method according to claim 16, which comprises introducing the blowing agent in the form of solid, non-preexpanded pellets into the mixture for the molding composition.

21. The method according to claim 16, which comprises admixing small proportions of thermally unstable, gas-releasing substances into the molding composition in addition to and physically separate from the expandable polystyrene particles, to form micropores in the shaped body.

22. The method according to claim 16, which comprises adding space occupier particles that are chemically soluble or that can be volatilized by way of pyrolysis to the molding composition in addition to the polystyrene particles and physically separate therefrom, to form micropores in the shaped body.

23. The method according to claim 16, which comprises forming a proportion by volume of cell-forming pores of greater than 30% and less than 85%, based on a volume of the sintered shaped body, on foaming.

24. The method according to claim 23, which comprises producing cell-forming pores having a mean diameter of 0.1-10 mm and a proportion of 60-85% by volume, based on a final state in the sintered shaped body.

25. The method according to claim 16, which comprises removing the blowing agents and the organic components by dissolving in organic solvents.

26. The method according to claim 16, which comprises pyrolytically removing the blowing agent.

27. The method according to claim 16, which comprises effecting the shaping and foaming process steps after an extrusion step.

28. The method according to claim 16, which comprises introducing metal powder selected from the group consisting of Fe, Co, Ni, Cu, Ti, Ta, Mo, W and noble metals in the form of pure metal, oxide, nitride, and/or hydride into the mixture for the molding composition.

29. The method according to claim 16, which comprises introducing the metal powder in the form of a type of hard metal into the mixture for the molding composition.

30. The method according to claim 16, which comprises using a mixture of various binder components having a predominant proportion by weight of polyamide.
